(19) United States
(12) Patent Application Publication
(10) Pub. No.: US 2014/0085436 A1
(43) Pub. Date: Mar. 27, 2014

(54) Systems and Methods for Convergent Angular Slice True-3D Display

(71) Applicant: Third Dimension IP LLC, Knoxville, TN (US)

(72) Inventors: David L. Page, Knoxville, TN (US); Clarence E. Thomas, JR., Knoxville, TN (US)

(73) Assignee: Third Dimension IP LLC, Knoxville, TN (US)

(21) Appl. No.: 14/033,273

(22) Filed: Sep. 20, 2013

Related U.S. Application Data
(60) Provisional application No. 61/704,285, filed on Sep. 21, 2012.

(51) Int. Cl. H04N 13/04; G02B 27/22

(52) U.S. Cl. CPC H04N 13/0459; G02B 27/2228
USPC 348/54; 353/7

(57) ABSTRACT

Systems and methods for convergent 3D displays. In one embodiment, the 3D display has a display screen that includes a convergent reflector and a horizontally narrow angle diffuser. The convergent reflector focuses 2D images projected on the diffuser from an array of 2D image projectors to form viewpoints in an eyebox where one viewpoint corresponds to one projector. At a particular viewpoint, the viewer's eye sees a full-screen field of view from a corresponding projector in the array. The narrow angle diffuser diffuses incident rays projected from the 2D image projectors into narrow angular slices so that the views in the eyebox are continuously blended together. The system and methods provide advantages in that only a few projectors are required in the array to provide the viewer with a full-screen field of view and a sufficiently large eyebox for comfortable viewing.

### CROSS-REFERENCE TO RELATED APPLICATIONS

This application claims the benefit of U.S. Provisional Patent Application 61/704,285, filed Sep. 21, 2012, which is incorporated by reference as if set forth herein in its entirety.

### BACKGROUND

1. Field of the Invention

Embodiments of the present invention relate generally to the field of three-dimensional (3D) displays, and more specifically to systems and methods for true-3D display suitable for multiple viewers without use of glasses or tracking of viewer position, where each of the viewers' eyes sees a slightly different scene (stereopsis), and where the scene viewed by each eye changes as the eye changes position (parallax).

2. Related Art

Over the last 100 years, significant efforts have gone into developing three-dimensional (3D) displays. There are existing 3D display technologies, including DMD (digital-mirror-device, Texas Instruments) projection of illumination on a spinning disk in the interior of a globe (Actuality Systems); another volumetric display consisting of multiple LCD scattering panels that are alternately made clear or scattering to image a 3D volume (LightSpace/Vizta3D); stereoscopic systems requiring the user to wear goggles (“Crystal Eyes” and others); two-plane stereoscopic systems (actually dual 2D displays with parallax barrier, e.g. Sharp Actius RD3D); and lenticular stereoscopic arrays (many tiny lenses pointing in different directions, e.g., Phillips nine-angle display, SID, Spring 2005). Most of these systems are not particularly successful at producing a true 3D perspective at the users eye or else are inconvenient to use, as evidenced by the fact that the reader probably won't find one in her/his office. The Sharp notebook only provides two views (left eye and right eye, with a single angle for each eye), and the LightSpace display appears to produce very nice images, but in a limited volume (all located inside the monitor) and would be very cumbersome to use as a projection display.

Beyond these technologies there are efforts in both Britain and Japan to produce a true holographic display. Holography was invented in the late 1940s by Gabor and started to flourish with the invention of the laser and off-axis holography. The British work, has actually produced a display that has a ˜7 cm extent and an 8 degree field of view (FOV). While this is impressive, it requires 100 million pixels (Mpixels) to produce this 7 cm field in monochrome and, due to the laws of physics, displays far more data than the human eye can resolve from working viewing distances. A working 50 cm (20 inch) color holographic display with a 60-degree FOV would require 500 nanometer (nm) pixels (at least after optical demagnification, if not physically) and more than a Terapixel (1,000 billion pixels) display. These numbers are totally unworkable anytime in the near future, and even going to horizontal parallax only (HPO, or three-dimensional in the horizontal plane only) just brings the requirement down to 3 Gpixels (3 billion pixels.) Even 3 Gpixels per frame is still a very unworkable number and provides an order of magnitude more data than the human eye requires in this display size at normal working distances. Typical high-resolution displays have 250-micron pixels—a holographic display with 500 nm pixels would be a factor of 500 more dense than this—clearly far more data would be contained in a holographic display than the human eye needs or can even make use of at normal viewing distances. Much of this incredible data density in a true holographic display would just go to waste.

A volumetric 3D display has been proposed by Balogh and developed by Holografika. This system does not create an image on the viewing screen, but rather projects beams of light from the viewing screen to form images by intersecting the beams at a pixel point in space (either real—beams crossing between the screen and viewer, or virtual—beams apparently crossing behind the screen as seen by the viewer). Resolution of this type of device is greatly limited by the divergence of the beams leaving the screen, and the required resolution (pixel size and total number of pixels) starts to become very high for significant viewing volumes.

Eichenlaub teaches a method for generating multiple autostereoscopic (3D without glasses) viewing zones (typically eight are mentioned) using a high-speed light valve and beam-steering apparatus. This system does not have the continuously varying viewing zones desirable for a true 3D display, and has a large amount of very complicated optics. Neither does it teach how to place the optics in multiple horizontal lines (separated by small vertical angles) so that continuously variable autostereoscopic viewing is achieved. It also has the disadvantage of generating all images from a single light valve (thus requiring the very complicated optical systems), which cannot achieve the bandwidth required for continuously variable viewing zones.

Nakamuna, et al., have proposed an array of micro-LCD displays with projection optics, small apertures, and a giant Fresnel lens. The apertures segregate the image directions and the giant Fresnel lens focuses the images on a vertical diffuser screen. This system has a number of problems including: 1) extremely poor use of light (most of the light is thrown away due to the apertures); 2) exceedingly expensive optics and lots of them, or alternatively very poor image quality; 3) very expensive electronics for providing the 2D array of micro-LCD displays.

Thomas has described an angular slice true 3D display with full horizontal parallax and a large viewing angle and field of view. The display however requires a large number of projectors to operate, and is therefore relatively expensive.

### SUMMARY OF THE INVENTION

Embodiments of the present invention include 3D displays. One embodiment has a display screen that consists of a convergent reflector and a narrow angle diffuser. The 3D display has an array of 2D image projectors that project 2D images onto the display screen to form 3D imagery for a viewer to see. The convergent reflector of the display screen enables full-screen fields of view for the viewer using only a few projectors (at least one, but nominally two or more for 3D viewing). The narrow angle diffuser of the display screen provides control over the angular information in the 3D imagery such that the viewer sees a different image with each eye (stereopsis) and, as the viewer moves her head, she sees different images as well (parallax). Accordingly, several advantages of one or more aspects are as follows: to provide no-glasses-required 3D imagery to a viewer without head tracking or other cumbersome devices; to present both depth and parallax, that does not require exotic rendering geometries or camera optics to generate 3D content; and to require only a few projectors to generate full-screen fields of view for both eyes. Other advantages of one or more aspects will be apparent from a consideration of the drawings and ensuing description.

One embodiment is a system having one or more 2D image projectors and a display screen which is optically coupled to the 2D image projectors. The 2D image projectors are configured to project individual 2D images substantially in focus on the display screen. The display screen is configured to optically converge each projected 2D image from the corresponding 2D image projector to a corresponding viewpoint, where the ensemble of the viewpoints form an eyebox. Each pixel from each of the 2D images is projected from the display screen into a small angular slice to enable a viewer observing the display screen from within the eyebox to see a different image with each eye. The image seen by each eye varies as the viewer moves his or her head with respect to the display screen.

The 2D image projectors may consist of lasers and scanning micro-mirrors that are optically coupled to the lasers, so that the 2D image projectors lenslessly project the 2D images on the display screen. The 2D image projectors driven by laser light sources may allow the 2D images to be substantially in focus at all locations (i.e., in all planes transverse to the optical axis of the system). The system may be configured to generate each of the 2D images from a perspective of the viewpoints in the eyebox, and to provide each of the 2D images to the corresponding projector. The system may be configured to anti-alias the 2D images according to an angular slice horizontal projection angle δθ between the projectors. The system may obtain one or more of the 2D images by rendering 3D data from a 3D dataset, or one or more still or video cameras (e.g., from 3D cameras, such as image plus depth-map cameras). The system may convert video streams into the 3D dataset and then render the 2D images from the 3D dataset. The system may obtain some of the 2D images by shifting or interpolation from others of the 2D images obtained from the cameras, and may substantially proportionally match a depth of field of the cameras to a depth of field for the system. The 2D image projectors may form a plurality of separate groups to form multiple eyeboxes, from which viewers may each observe the display. Each eyebox may be large enough for a plurality of viewers. The shape of the display screen may be selected from the group consisting of cylinders, spheres, parabolas, ellipsoids and aspherical shapes.

Numerous alternative embodiments are also possible.

### BRIEF DESCRIPTION OF THE DRAWINGS

Other objects and advantages of the invention may become apparent upon reading the following detailed description and upon reference to the accompanying drawings.

FIG. 1 is a perspective view of one embodiment with convergent reflective diffuser;

FIG. 2 is a top view of FIG. 1 with eyebox;

FIG. 3 is the perspective view of FIG. 1 with convergent projector rays;

FIG. 4 is a top view of FIG. 1 with full-screen field of view;

FIG. 5 is a top view of FIG. 1 with depth of field; and

FIG. 6 is a top view of FIG. 1 with horizontal angular diffusion.

FIG. 7 is an operation diagram.

FIG. 8 is a perspective view of another embodiment with stacked array.

FIG. 9 is a front view comparing projector spacing in FIGS. 1 and 8.

FIG. 10 is a perspective view of another embodiment with offset-in-depth viewer.

FIG. 11 is a perspective view of another embodiment with overhead array.

FIG. 12 is a perspective view of another embodiment with multiple viewers and overhead array.

FIG. 13 is a perspective view of another embodiment with spherical reflective diffuser.

FIG. 14 is a perspective view of another embodiment with diffusion before convergence; and

FIG. 15 is a top view of FIG. 14 with ray projection.

FIG. 16 is a perspective view of another embodiment with diffusion after convergence; and

FIG. 17 is a top view of FIG. 16 with ray tracing.

While the invention is subject to various modifications and alternative forms, specific embodiments thereof are shown by way of example in the drawings and the accompanying detailed description. It should be understood, however, that the drawings and detailed description are not intended to limit the invention to the particular embodiment which is described. This disclosure is instead intended to cover all modifications, equivalents and alternatives falling within the scope of the present invention as defined by the appended claims. Further, the drawings may not be to scale, and may exaggerate one or more components in order to facilitate an understanding of the various features described herein.

### DETAILED DESCRIPTION OF EXEMPLARY EMBODIMENTS

### First Embodiment

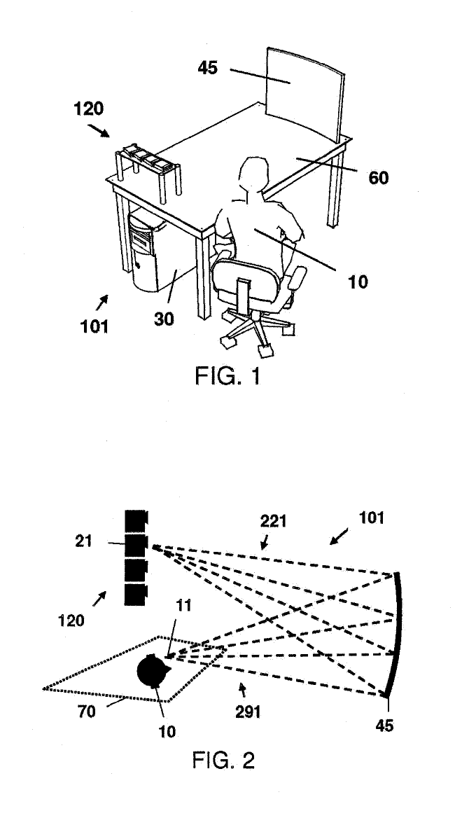

### FIGS. 1-6

The present invention and the various features and advantageous details thereof are explained more fully with reference to the non-limiting embodiments that are illustrated in the accompanying drawings and detailed in the following description. Descriptions of well-known components and processing techniques are omitted so as not to unnecessarily obscure the present invention in detail.

One embodiment of the 3D display is illustrated in FIG. 1 (perspective view) showing a 3D display 101 and a viewer 10. The display 101 has a display screen that consists of a convergent (e.g., cylindrically curved) reflective diffuser 45. The display 101 also has an array 120 of image projectors (at least one projector but nominally two or more for 3D). The image projectors in the array 120 project a set of 2D images onto the diffuser 45, which forms 3D imagery for the viewer 10. The set of 2D images are generated by a rendering computer 30 that is linked (cabled or wireless) to the array 120. A mounting structure 60 maintains a rigid physical link between the diffuser 45 and the array 120 to maintain system alignment, although any system that maintains a fixed relationship between the projectors and screen will work. The construction materials for the mount 60 are chosen to give structural support and to maintain geometric alignment through ambient temperature cycles. The construction materials can consist of any material that can provide sufficient support and maintain alignment over a designated temperature range.

In one embodiment, the display 101 provides horizontal parallax only (HPO) 3D imagery to the viewer 10. For HPO, the diffuser 45 reflects and diffuses incident light over a wide range vertically (say 20 degrees or more, the vertical diffusion angle is chosen so that adequate and similar intensity light reaches the viewer from the top and bottom of the diffuser), but only over a very small angle horizontally (say one degree or so). An example of this type of asymmetric reflective diffuser is a holographically produced Light Shaping Diffuser from Luminit LLC (1850 West 205th Street, Torrance, Calif. 90501, USA). Luminit's diffusers are holographically etched high efficiency diffusers, referred to as holographic optical elements (HOE's). Luminit is able to apply a reflective coating (very thin layer, conformable coating of, for example, aluminum or silver) to the etched surfaces to form reflective diffusers. Other types of diffusers (not necessarily HOE) with similar horizontal and vertical characteristics (e.g., arrays of micro-lenses) are usable along with other possible reflective coatings (e.g. silver/gold alloy). Similarly, thin film HOE diffusers over the top of a reflector can perform the same function.

In one embodiment, referring now to FIG. 2, the diffuser 45 is flexible, such as Luminit's acrylic diffusers. The flexible diffuser 45 can be bent to a cylindrical shape (horizontally focusing reflector) with a radius of curvature, R. In other embodiments, diffusers manufactured directly with a rigid cylindrical shape are usable. Other focusing shapes such as spherical are possible, but the cylindrical shape simplifies the geometry while also generating a large vertical eyebox. The radius of curvature R for the diffuser 45 is such that a bundle 221 of light rays that emanates and diverges from projector 21 in FIG. 2 (top view of FIG. 1), converges as a reflected bundle 291 approximately to a viewpoint 11. (Since the reflector also diffuses horizontally with a small diffusion angle, only the principal ray of each diffused ray is tightly focused, the other rays are diffused in a narrow angle around the focus of the principal rays.) A perspective view of the ray bundles 221 and 291 appears in FIG. 3.

Referring again to FIG. 2, the viewpoint 11 is within a volumetric region known as an eyebox 70. The eyebox 70—which is not strictly a geometric box but a figurative one—is a region where the viewer 10 can position his head such that both his eyes see full-screen 3D imagery, a maximal field of view of the diffuser 45. As with projector 21, within the eyebox 70, there exists, for each projector in the array 120, a viewpoint (approximately a point for the principal rays with the diffused rays in a small angle horizontally around it and spatially distinct from other projectors) where a ray bundle (full image) emitted from a particular projector converges, following optical properties of convergent reflectors. Thus, within the eyebox 70, the viewer 10 sees the 3D imagery in full screen (complete field of view), and while outside the eyebox 70, the viewer 10 sees a partial screen or possibly nothing.

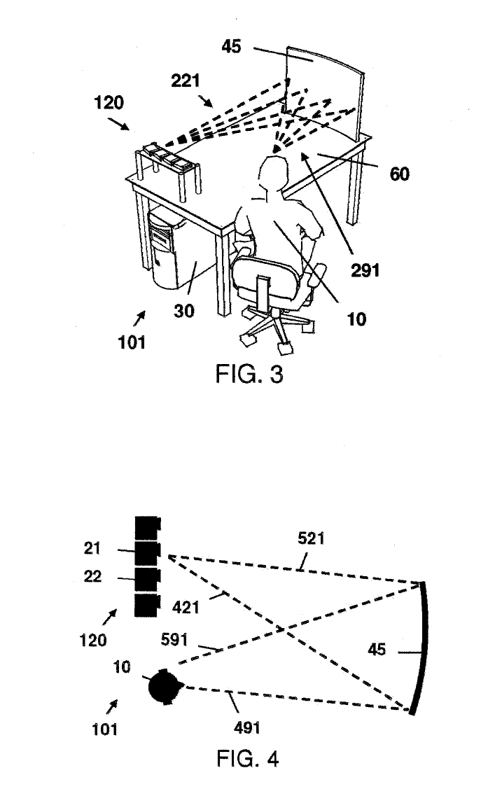

Maximal (full screen) rays from each projector in the array 120 define a boundary for the eyebox 70 (FIG. 2). Consider the projector 21 in FIG. 4 as an example. Projector 21, as with each projector, is oriented such that edge rays 421 and 521 of the projected 2D image substantially fill the desired viewable area of the diffuser 45. Additionally, each projector has the required optics such that the projected 2D image is substantially in focus at the diffuser 45. For the viewer 10, the full-screen field of view for projector 21 is illustrated by edge rays 491 and 591. Ray 421 reflects and diffuses such that the resulting diffusion cone has a maximal extent represented by ray 491. Similarly, ray 591 represents the maximal extent of the reflected diffusion cone for ray 521. Thus, the rays 491 and 591 define the full-screen field of view for the viewer 10 of projector 21 for a viewer near the focus of the principal (undiffused) rays. An eye substantially near the focus and within the area between rays 491 and 591 will see a full-screen as imaged by projector 21 on the focusing diffuser 45. The ensemble of full-screen boundary rays from each projector in the array 120 form the eyebox 70 (FIG. 2).

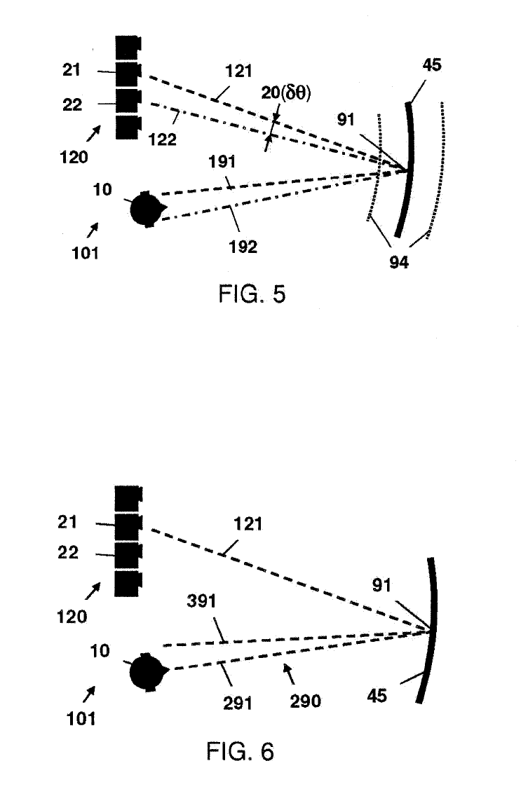

The extent of the eyebox 70 in FIG. 2 is further defined by angular displacement 20 (δθ), shown in FIG. 5, between the projectors in the array 120. For HPO, this angular displacement 20 is only required in the horizontal direction. The angular displacement 20 is nominally such that the angle between the projectors is one degree or less, as measured from the diffusion screen 45, where a pixel ray 121 from the projector 21 and a pixel ray 122 from a projector 22 define the angular displacement 20 such that ray 121 and 122 illuminate a common point 91 on the diffuser 45. The angular displacement 20 is a tradeoff between maximizing the eyebox size 70 in FIG. 2 while minimizing spatial blurring in the displayed 3D imagery.

Spatial blurring is the apparent defocusing of the 3D imagery as a function of visual depth within a given scene. Objects that visually appear at the diffuser 45 are always in focus, and objects that appear further away in 3D space than the diffuser 45 have increasing apparent defocus. An acceptable range of spatial blurring around the diffuser 45 for the typical viewer is known as depth of field. A depth of field 94 is illustrated in FIG. 5 by two dotted lines on either side of the diffuser 45 to show the near and far boundaries of the depth of field. Closer angular displacement 20 (smaller angular gap between projectors) increases the range for the depth of field 94. However, for a fixed number of projectors, closer displacement also reduces the relative size of the eyebox 70 in FIG. 2.

The horizontal angular displacement 20 and the diffuser 45 with limited horizontal angular diffusion are elements that work jointly to present 3D imagery to the viewer 10. In FIG. 5, each eye of the viewer 10 sees a different full-screen image from different projectors—one eye sees one projector while the other eye sees a different projector. For example, ray 121 from projector 21 reflects and diffuses to form a ray 191 that travels to the left eye of the viewer while ray 122 from projector 22 reflects and diffuses to form a ray 192 that travels to the right eye of the viewer. This ray geometry results from the properties of the diffuser 45, which limit the amount of reflected light from any particular ray to a narrow horizontal angular extent.

For example, in FIG. 6, rays 291 and 391 represent the full width at half maximum (FWHM) intensity boundaries (horizontally) for a cone 290 of light reflected and diffused from ray 121. Thus, ray 191 in FIG. 5 is within the cone 290 of ray 121 as is ray 192 for a diffusion cone of ray 122. The angular displacement 20 of the projectors and the FWHM angular diffusion 290 of the diffuser 45 are interrelated. By construction, incident rays (e.g. rays 121 and 122) from separate projectors reflect at a common point (e.g. point 91) on the diffuser 45. The reflected chief rays of the resulting diffuse ray bundles have the same angular displacement 20 as the projectors. Similarly, the ray bundles overlap as defined by the FWHM specification of the diffuser 45. For the viewer 10 in the eyebox 70, this overlap provides a blending of projected imagery as the viewer 10 moves her head throughout the eyebox 70. Thus, a tradeoff exists such that a broader FWHM diffusion angle reduces intensity variations within the eyebox 70 (assuming projectors with fairly matched intensities either by manufacture or through calibration) while a narrower FWHM diffusion angle reduces spatial aliasing, which is closely related to spatial blurring discussed previously.

The drawings in FIGS. 1-6 show four projectors as a simple illustration, but more projectors in the array 120 are possible. As the number of projectors in the array 120 increases, the relative size of the eyebox 70 in FIG. 2 also increases, all other things being equal.

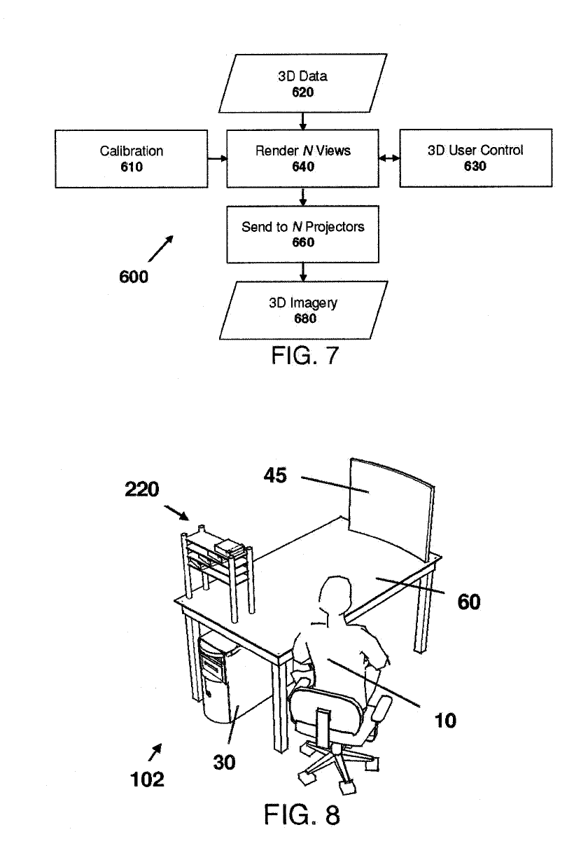

### Operation—FIG. 7

A block diagram in FIG. 7 illustrates the operation of the 3D display 101. A 3D data set 620 serves as the input to a display algorithm 600 where this data can consist of 3D geometry from an OpenGL-compliant computer application, 3D geometry from Microsoft's proprietary graphics interface known as Direct3D, a sequence of digital video (or still) images representing different viewpoints of a real-world scene, a combination of digital images and depth maps as is possible with Microsoft's Kinect camera, or other inputs that suitably describe 3D imagery. The algorithm 600 executes on the rendering computer 30. An output of the algorithm 600 is 3D imagery 680 suitable for the viewer 10 within the eyebox 70.

The algorithm 600 uses a rendering step 640 to generate the appropriate 2D images required to drive each projector in the array 120. The rendering step 640 uses parameters from a calibration step 610 to configure and align the 2D images such that as the viewer 10 moves his head within the eyebox 70, he sees blended 3D imagery without distortions from inter-projector misalignments or intra-projector mismatches. A user (perhaps the viewer 10) is able to control the rendering step 640 through a 3D user control step 630. This step 630 allows the user to change manually or automatically parameters such as the apparent parallax among the 2D images, the scale of the 3D data, the virtual depth of field and other rendering variables.

The rendering step 640 uses a 2D image projection specific to each projector as defined by parameters from the calibration step 610. For a particular projector, the 2D image projection has a viewpoint within the eyebox 70, such as the viewpoint 11 in FIG. 2, for example. In one embodiment the 2D image projection is a standard frustum commonly available in OpenGL rendering. Other projections such as in Microsoft's Direct3D are also usable. The 2D image projection follows the convergent ray geometry, such as the ray bundle 291 in FIG. 2 for example, where the projection extends virtually behind the diffuser 45. In other embodiments, the control step 630 is able to adjust the viewpoint and the 2D image projection beyond the calibrated parameters although doing so introduces distortions into the 3D imagery for the viewer 10, which may be acceptable in certain applications.

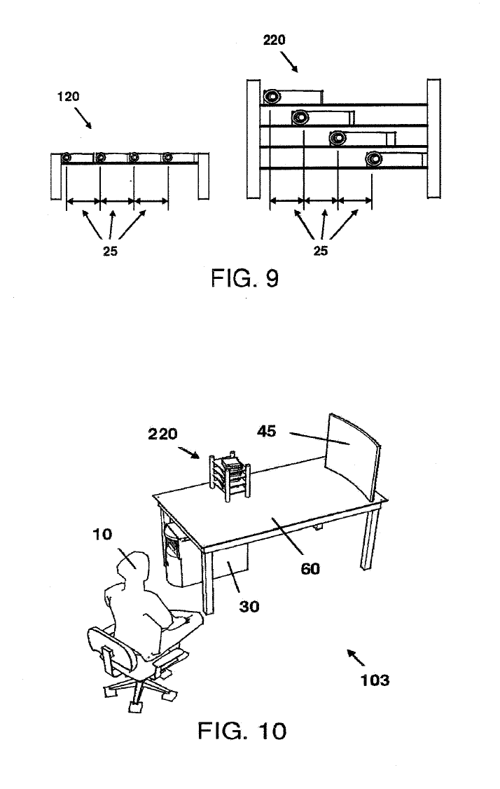

### Stacked Projector Array—FIG. 8 and FIG. 9

An additional embodiment is shown in FIG. 8 where a 3D display 102 has a stacked projector array 220. The array 220 consists of projectors that are physically too large to fit on the same row and achieve the angular displacement 20 as in the array 120 in FIG. 1. By placing the projectors onto vertically separated trays, the array 220 achieves the required horizontal displacement 20 for HPO 3D imagery. A comparison in FIG. 9 shows the front views of array 120 and array 220 with each having a horizontal linear displacement 25 that is a function of the horizontal angular displacement 20 (δθ) in FIG. 1. For the arrays 120 and 220, the linear displacement 25 is the same horizontal distance since the arrays 120 and 220 are at the same depth away from the diffuser 45. Since projectors in array 120 are physically smaller than projectors in 220, the projectors in array 120 can be placed on a single row, whereas the projectors in array 220 require multiple rows. The vertical displacement of the projectors in array 220 does not substantially affect the 3D imagery for HPO since the diffuser 45 has a broad vertical diffusion (20 degrees or more). The vertical displacement may introduce small variations in intensity as perceived by the viewer 10, but the calibration step 610 in FIG. 7 (display operation) can correct for these variations.

### Offset-in-Depth Viewer—FIG. 10

An additional embodiment is shown in FIG. 10 where a 3D display 103 has the stacked projector array 220 such that the viewer 10 is at a different distance from the diffuser 45 than the array 220 is from the diffuser 45. The array 220 has the same angular displacement 20 of projectors as in the array 120 in FIG. 1 and as in the array 220 in FIG. 8. However, to achieve the angular displacement 20, projectors in array 220 have a smaller horizontal linear displacement than the linear displacement 25 in arrays 120 or 220. Thus, projectors in array 220 are closer together (in a horizontal linear sense) since they are closer to the diffuser 45. The placement of the array 220 closer to the diffuser 45 means that the viewer 10 and a subsequent eyebox for the viewer 10 are farther away from the diffuser 45, for a given cylindrical curvature of the diffuser. Note that in FIG. 10, the viewer 10 is farther back from the table while the array 220 is closer to the diffuser 45, compared to previous drawings. This geometry follows the focusing properties of a convergent mirror.

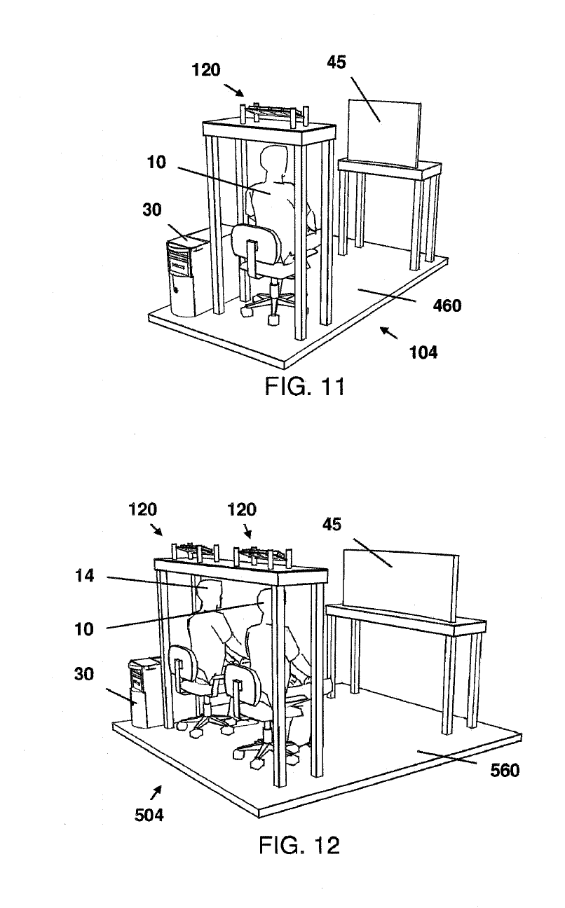

### Overhead Projector Array—FIG. 11 and FIG. 12

An additional embodiment is shown in FIG. 11 where a 3D display 104 has the viewer 10 and a subsequent eyebox for the viewer 10 directly beneath the projector array 120. The display 104 may have the diffuser 45 tilted so that the specular reflection of vertical components of the reflected rays from the center of the diffuser is towards the viewer. The diffuser 45 has a broad vertical angle of diffusion (FWHM of 20 degrees or more) and thus rays from the projector array 120 reflect and diffuse to reach the viewer 10. The projectors in the array 120 still have the horizontal angular displacement 20 as shown in FIG. 5.

Referring now to FIG. 12, multiple viewers are also possible with convergent diffuser geometry. In this figure, a 3D display 504 has the viewer 10 along with another viewer 14. These viewers are positioned to observe the cylindrical diffuser 45 such that projector array 120 generates 3D imagery for viewer 10 and a second array 120 generates 3D imagery for viewer 14. Note that the viewers and projector arrays have diametric symmetry following the focusing properties of a convergent mirror. This embodiment illustrates that multiple viewers can be accommodated by using multiple projector arrays.

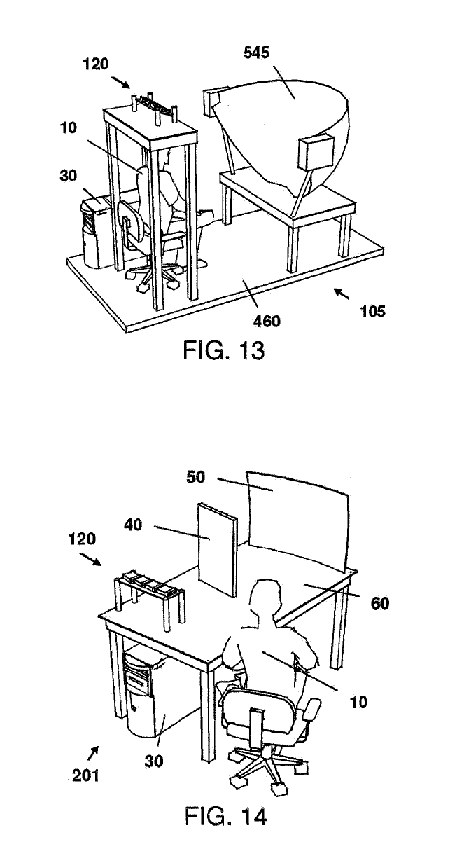

### Spherical Reflector—FIG. 13

An additional embodiment is a 3D display 105 shown in FIG. 13, which uses a spherically curved (reflective) diffuser 545 for the display screen. As before, the projected images are substantially in focus at the reflective diffuser. Other convergent reflector shapes are usable including parabolic and toroidal such that the shape collects the light rays and approximately focuses the rays to a viewpoint in one or more dimensions. Which is to say, for the viewer 10, the rays from a projector in the array 120 are diffused and reflected from the shape and converge approximately to a viewpoint within an eyebox for the viewer 10. The shape of the eyebox volume will change depending on the shape of the reflector.

The advantage of this type of convergent angular slice true-3D display is that many fewer projectors are required to produce a full horizontal parallax 3D image (view changes continuously with horizontal motion) than with a flat-screen angular slice display (ASD). Note that the projectors can be located to the side of the viewer or below the viewer just as well as above the viewer.

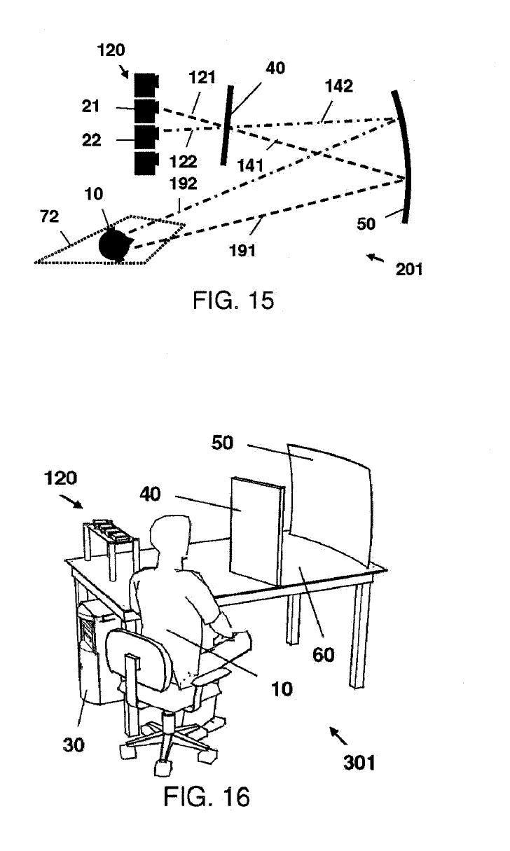

Diffusion before Convergence—FIG. 14 and FIG. 15

An additional embodiment is shown in FIG. 14 (perspective view) where a display screen for a 3D display 201 consists of a diffusion screen 40 and a spherically curved (horizontally and vertically focusing) mirror 50. Further detail is shown in FIG. 15 (top view with ray geometry). Unlike the diffuser 45 in FIGS. 1-13, the diffusion screen 40 and the mirror 50 are physically separated in the display 201. The diffusion screen 40 is between the projector array 120 and the mirror 50 such that diffusion occurs before ray focusing. Note that the images from the projectors are substantially in focus at the diffusion screen 40. The diffusion screen 40 has transmission diffusion properties (horizontal FWHM angle the order of one degree or less, and vertical FWHM angle the order of 20 degrees or more) similar to the previously discussed reflective diffuser 45 in FIGS. 1-13. For projector 21, the pixel ray 121 diffuses through the diffusion screen 40 and forms a diffuse ray bundle centered on a chief ray 141. The chief ray 141 and the diffuse bundle reflect from the mirror 50 as defined by a reflected chief ray 191. In a similar manner, a reflected chief ray 192 is formed from the diffusion of the pixel ray 122 from projector 22 to form a diffuse ray bundle centered on a chief ray 142. The chief rays from any single projector (undiffused center ray from each pixel on the diffusion screen 40) are all focused in the vicinity of the eyebox 72, and the diffused rays blend together between the projector foci to form the eyebox. The 3D scene that is experienced by the viewer 10 will be magnified or demagnified by reflecting from the spherical mirror 50 according to the laws of optics.

The reflected chief rays (for example rays 191 and 192) from each projector converge to form viewpoints within an eyebox 72. Given a radius of curvature R for the mirror 50, the horizontal extent of the eyebox 72 is defined in a manner similar to the ray geometry in FIG. 2. Also, the vertical extent of the eyebox 72 is much smaller than the vertical extent of eyebox 70 in FIG. 2. The spherical shape of the mirror 50 converges the chief rays both horizontally and vertically to form eyebox 72. The diffusion screen characteristics are chosen so that the projector views blend into each other horizontally as the viewer moves his head horizontally.

Although a depth of field for the display 201 is centered at the diffusion screen 40, the apparent location of the depth of field to the viewer 10 follows convergent mirror geometry for object and image distances. For example in one embodiment, if the diffusion screen 40 is a distance 0.5 R from the mirror 50, then the apparent center for the depth of field approaches infinity.

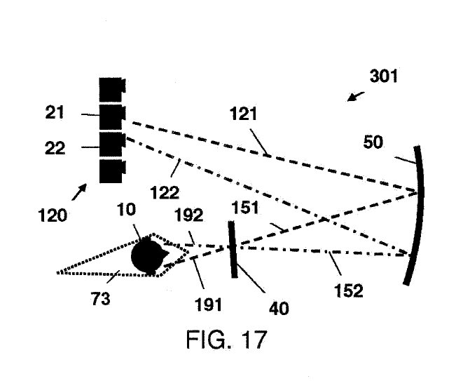

Diffusion after Convergence—FIG. 16 and FIG. 17

An additional embodiment is shown in FIG. 16 (perspective view) where a 3D display 301 has the diffusion screen 40 between the viewer 10 and the spherically curved mirror 50. Further detail of the ray geometry appears in FIG. 17. With this geometry, the rays 121 and 122 are first reflected to form rays 151 and 152 and are then diffused to form the rays 191 and 192. These rays are exemplary for the rays from the projectors in the array 120. A depth of field is centered about the screen 40, and the 3D display 301 has an eyebox 73 defined by a full-screen field of view for boundary projectors in the array 120. Note that the projectors are substantially in focus on the diffusion screen 40. As before the chief rays from each projector through each pixel on the diffusion screen 40 focus to a point in the eyebox 73, and the diffused rays blend the images evenly together as the viewer moves her head horizontally within the eyebox. The horizontal diffusion characteristics of the diffuser are chosen to achieve this effect.

### Full Parallax 3D Display

An additional embodiment is a full parallax 3D display. Full parallax means that the viewer sees a different view not only with horizontal head movements (as in HPO) but also with vertical head movements. One can think of HPO as the ability for the viewer to look around objects horizontally, and full parallax as the ability to look around objects both horizontally and vertically. Full parallax is achieved with a diffuser that has both a narrow horizontal angular diffusion and a narrow vertical angular diffusion. (Recall that HPO requires only narrow diffusion in the horizontal while the vertical has broad angular diffusion.) As noted previously, the angular diffusion is tightly coupled with the angular displacement of the projectors in the array. Again, recall that HPO requires proportionally matching the horizontal angular displacement 20 (FIGS. 5 and 9) of the projectors with the FWHM horizontal diffusion angle. With full parallax, the vertical angular displacement of the projectors is required to proportionally match the narrow vertical diffusion angle. Thus, while the array 120, having a single row of N projectors with horizontal angular displacement 20, is possible for HPO as in FIG. 9, full parallax requires an array having a matrix of N×M projectors with both horizontal and vertical displacement to achieve a similar field of view as the HPO array.

### Advantages

From the descriptions above, a number of advantages of some embodiments of the angular convergent true 3D display become evident, without limitation:

(a) No special glasses, head tracking devices or other instruments are required for a viewer to see 3D imagery, thus avoiding the additional cost, complexity, and annoyances for the viewer associated with such devices.

(b) No moving parts such as spinning disks, rasterizing mirrors or shifting spatial multiplexers are required, which thereby increases the mechanical reliability and structural integrity.

(c) Since image projectors, by construction, project 2D images such that rays diverge from the projector lens, the use of a convergent reflector has the advantage of focusing these rays into the eyebox. This property makes rendering the 2D images to form the 3D imagery simpler since standard projection geometries, where horizontal and vertical projection foci share approximately the same location, are used to form the 2D images without the need for non-standard projections such as anamorphic where horizontal and vertical projection foci do not share the same location. Thus, 2D imagery from digital (still or video) cameras with standard lens can be used to drive the projectors directly without additional processing to account for the divergent projector rays.

(d) The convergence at the eyebox of the projected 2D images permits the use of a single projector in the array to achieve a full-screen field of view to a viewer in the eyebox. Additional projectors simply increase the size of the eyebox and the parallax in the displayed 3D imagery for the viewer. Thus, only a few projectors (nominally two or more) are required for viewing full-screen 3D imagery, which reduces system cost.

(e) The separation of the diffuser and the convergent mirror permits the adjustment of the apparent center for the depth of field (relative to the viewer) in accordance with convergent mirror geometry for object and image distances. This adjustment has the advantage to display 3D imagery with an apparent depth of field required by a particular application.

Accordingly, the reader will see that the 3D display of the various embodiments can be used by viewers to see 3D imagery without special glasses, head tracking or other constraints. The viewer sees different views with each eye and can mover his head to see different views to look around objects in the 3D imagery.

Although the description above contains many specificities, these should not be construed as limiting the scope of the embodiments but as merely providing illustrations of some of several embodiments. For example, the convergent reflectors can have different shapes such as cylindrical, spherical, toroidal, etc.; the display screen can consist of a single convergent reflective diffuser, of a transmitting diffuser followed by a convergent mirror, of a convergent mirror followed by a transmitting diffuser, etc.; the 2D images driving the image projectors can be derived from renderings of 3D data, video streams from one or more cameras, video images converted to 3D data and then rendered, etc.

The benefits and advantages which may be provided by the present invention have been described above with regard to specific embodiments. These benefits and advantages, and any elements or limitations that may cause them to occur or to become more pronounced are not to be construed as critical, required, or essential features of any or all of the claims. As used herein, the terms “comprises,” “comprising,” or any other variations thereof, are intended to be interpreted as non-exclusively including the elements or limitations which follow those terms. Accordingly, a system, method, or other embodiment that comprises a set of elements is not limited to only those elements, and may include other elements not expressly listed or inherent to the claimed embodiment.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention as detailed within the following claims.

What is claimed is:

1. A system comprising:
one or more 2D image projectors; and
a display screen optically coupled to said 2D image projectors;
wherein the 2D image projectors are configured to project individual 2D images substantially in focus on the display screen;
wherein the display screen is configured to optically converge each projected 2D image from the corresponding 2D image projector to a corresponding viewpoint, wherein the ensemble of said viewpoints form an eyebox;
wherein each pixel from each of the 2D images is projected from the display screen into a small angular slice to enable a viewer within the eyebox observing said display screen to see a different image with each eye, wherein the image seen by each eye varies as the viewer moves his or her head with respect to the display screen;

2. The system of claim 1, wherein the 2D image projectors consist of one or more lasers and one or more scanning micro-mirrors optically coupled to the lasers, wherein the 2D image projectors are configured to lenslessly project the 2D images on the display screen.

3. The system of claim 1, wherein the 2D image projectors are driven by laser light sources such that the 2D image is substantially in focus at all locations.

4. The system of claim 1, wherein the system is configured to generate each of the 2D images from a perspective of the viewpoints in the eyebox, wherein each of the 2D images is provided to the corresponding projector.

5. The system of claim 1, wherein the system is configured to anti-alias the 2D images according to an angular slice horizontal projection angle δθ between the projectors.

6. The system of claim 1, wherein one or more of the 2D images is obtained by rendering 3D data from one or more 3D cameras.

7. The system of claim 1, wherein the 2D image projectors are formed into a plurality of separate groups such that a plurality of the eyeboxes is formed whereby a plurality of viewers may each observe from the plurality of eyeboxes.

8. The system of claim 1, wherein a plurality of the 2D image projectors is configured such that the eyebox formed is large enough for a plurality of viewers.

9. The system of claim 1, wherein a shape of the display screen is selected from the group consisting of cylinders, spheres, parabolas, ellipsoids and aspherical shapes.

10. The system of claim 1, wherein the system is configured to render the 2D images from a 3D dataset.

11. The system of claim 1, wherein the system is configured to obtain one or more of the 2D images from still or video cameras.

12. The system of claim 10, wherein the system is configured to convert video streams into the 3D dataset and then render the 2D images.

13. The system of claim 11, wherein one or more of the 2D images is obtained by shifting or interpolation from others of the 2D images obtained from the said still or video cameras.

14. The system of claim 11, wherein the system is configured to substantially match proportionally a depth of field of said still or video cameras to a depth of field for the system.

15. A system comprising:
one or more 2D image projectors;
a display screen optically coupled to said 2D image projectors; and
a converging optical element optically coupled to said 2D image projectors and said display screen
wherein the 2D image projectors are configured to project individual 2D images substantially in focus on the display screen;
wherein the converging optical element is configured to optically converge each projected 2D image from the corresponding 2D image projector to a corresponding viewpoint, wherein the ensemble of said viewpoints form an eyebox;
wherein each pixel from each of the 2D images is projected from the display screen into a small angular slice to enable a viewer within the eyebox observing said display screen to see a different image with each eye, wherein the image seen by each eye varies as the viewer moves his or her head with respect to the display screen;

16. The system of claim 15, wherein the converging optical element is between the 2D image projectors and the display screen.

17. The system of claim 15, wherein the converging optical element is between the display screen and one or more viewers.

18. The system of claim 15, wherein a shape of the converging optical element is selected from the group consisting of cylinders, spheres, parabolas, ellipsoids and aspherical shapes.

19. A method comprising:
generating multiple individual 2D images; and
projecting the individual 2D images substantially in focus onto a display screen;
wherein the display screen further projects the 2D images so as to optically converge each projected 2D image from the corresponding projected 2D image to a corresponding viewpoint, wherein the ensemble of said viewpoints form an eyebox;
wherein each pixel from each of the 2D images is further projected from the display screen into a small angular slice within said viewpoint to enable a viewer within the eyebox observing said display screen to see a different image with each eye, wherein the image seen by each eye varies as the viewer moves his or her head with respect to the display screen.
